(19) United States
(12) Patent Application Publication
(10) Pub. No.: US 2015/0199197 A1
(43) Pub. Date: Jul. 16, 2015

(54) VERSION MANAGEMENT FOR APPLICATIONS

(71) Applicants: Stephane H. Maes, Cupertino, CA (US); Rajeav Bharadhwaj, Cupertino, CA (US); Travis S. Tripp, Fort Collins, CO (US); Jan Vana, Trebon (CZ); Vasu Saslkanlh Sankhavaram, Cupertino, CA (US)

(72) Inventors: Stephane H. Maes, Cupertino, CA (US); Rajeav Bharadhwaj, Cupertino, CA (US); Travis S. Tripp, Fort Collins, CO (US); Jan Vana, Trebon (CZ); Vasu Saslkanlh Sankhavaram, Cupertino, CA (US)

(21) Appl. No.: 14/391,571

(22) PCT Filed: Jun. 8, 2012
(86) PCT No.: PCT/US2012/041679

§ 371 Date: Oct. 9, 2014

(51) Int. Cl. G06F 9/44; G06F 9/445; G06F 11/36

(52) U.S. Cl. CPC G06F 8/71; G06F 11/3672; G06F 8/65

(57) ABSTRACT

A system (100) includes an application model (140) to characterize a given application (110) for deployment on a cloud (130). A deployment manager (120) analyzes an application requirement for the given application (110) based on the application model (140) and policies (150) associated with the given application (110) to substantially match infrastructure resources (160) in the cloud (130) to fulfill the application requirement. A versioning manager (164) tracks changes in the given application (110) during a service lifecycle of the given application (110) and updates the application model (140) or the policies (150) in accordance with the changes.

### BACKGROUND

Cloud computing refers to the delivery of scalable and pooled computing, storage and networking capacity as a service to a network of end-recipients. The name comes from the use of clouds as an abstraction for the complex infrastructure of networks and associated hardware operative within the cloud. Cloud computing provides services for a user's data, software and computation over a network, for example. Such computing capability relies on sharing of resources to achieve coherence and economies of scale similar to a utility (like the electricity grid) over a network (typically the Internet). Applications deployed on resources supporting the cloud presently often have to be manually deployed and that consumes considerable administrative time. The manual steps of deploying the application include the provisioning and instantiation of the infrastructure. This requires linking the installation of the application or deployment of an image to the full knowledge of the deployed infrastructure. Manual deployment typically requires numerous sequences of steps usually launched by the user who attempts to deploy the application.

### BRIEF DESCRIPTION OF THE DRAWINGS

FIG. 1 illustrates an example of a system that provides automated versioning, test, management, and deployment for cloud applications.

FIG. 2 illustrates an example of a test manager interface for automated test, versioning, and deployment of applications in a cloud environment.

FIG. 3 illustrates an example system for automated versioning, deployment and monitoring of applications.

FIG. 4 illustrates an example system utilizing closed loop feedback for deployment, versioning, testing, and monitoring of applications.

FIG. 5 illustrates a flowchart of an example method for automated deployment and versioning of applications.

FIG. 6 illustrates an example deployment system for automated deployment and versioning of cloud applications.

FIG. 7 illustrates an example of a deployment manager for matching a resource capability for a cloud with an application requirement of an application.

### DETAILED DESCRIPTION

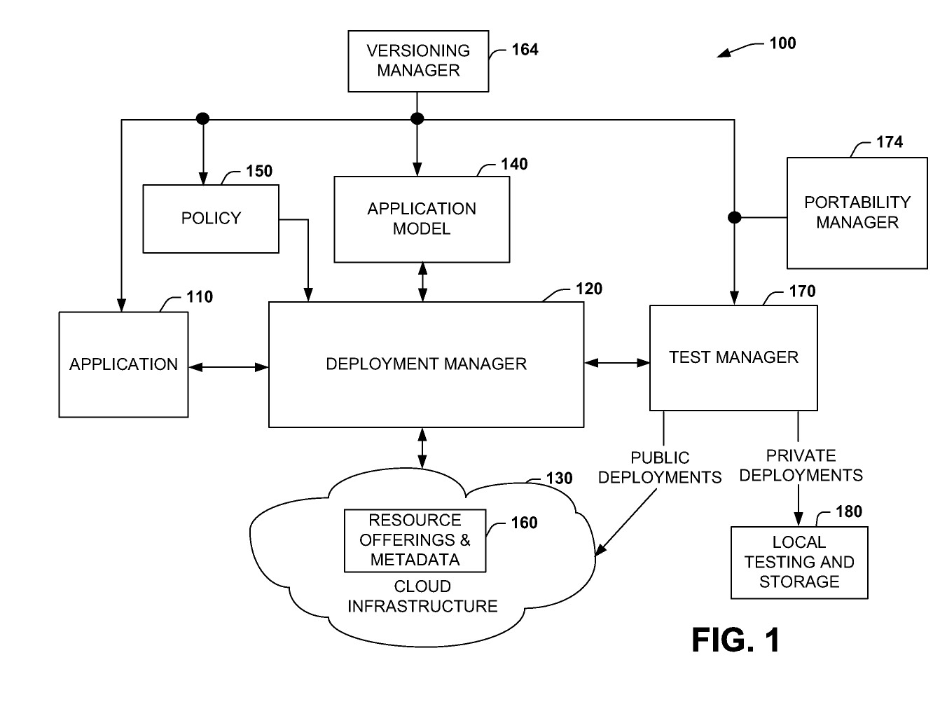

FIG. 1 illustrates an example of a system 100 that facilitates automated test, management, versioning, and deployment for cloud applications. The system 100 can provide automated deployment and life cycle management of an application 110 by utilizing a deployment manager 120 to determine infrastructure capabilities of a cloud infrastructure 130 (also referred to as cloud 130) and also determining application requirements of the application 110 by matching an application model 140 and policy 150 with cloud infrastructure resources. After such determinations, the deployment manager 120 can automatically manage the lifecycle of the application 110 on the cloud 130, wherein matches are identified (e.g., ideal or best effort—closest match). Based on a measure of closeness in the matching, and/or other policy requirements a match is selected and the infrastructure can be provisioned/instantiated.

According to such matching of cloud infrastructure resources (e.g., an absolute or closest match) to application requirements, then the components of the application 110 can be deployed on the cloud 130. Infrastructure capabilities of the cloud 130 can be determined via resource offerings and metadata 160 associated with the cloud. For instance, a plurality of service providers supporting the cloud 130 can provide files that specify what types of resources they have available and metadata that describe properties of interest for the respective resource offerings (e.g., resource offering of three servers available with metadata specifying memory size and processor speeds, load (if already instantiated), location, tenancy terms, service level agreements (SLAs), scheduled maintenances, and so forth).

A versioning manager 164 can be programmed to track changes in the application (e.g., to detect a version change) during a service lifecycle of the given application and, based on the detected changes, update the application requirements for deployment of the application in the cloud. For example, the versioning manager can update the application model 140 and/or the policies 150 for the given application in accordance with the changes. Alternatively, such updating of the models and/or policies can also be performed manually or via a tool/logical process that people or systems can fulfill. In general, the application 110 often migrates through many versions, deployments options, revisions, and so forth. Thus, applications, platforms, services, and policies all form a part of a service lifecycle. This service lifecycle can change over time with versions of each artifact that composes the service. The versioning manager 164 facilitates that components and dependencies between components of the application 110 are deployed in the cloud in workable manner over the course of the service lifecycle.

In addition to tracking changes, the versioning manager 164 can model dependent relationships between components and artifacts of the given application 110 which can then be updated in the application model 140 or the policy 150 based detecting changes in the given application. Such dependant relationships could be modeled as a tree, hierarchy, database structure, or other from, for example. Thus, when an upgrade or other change is performed on the application 110, the versioning manager 164 tracks the changes all versions of the application over the course of the service lifecycle. In another example, real time processing of application versions can facilitate backward compatibility with client/interactions/integrations with older systems by allowing instantiation of older versions when needed. For example, if a newer version of an application were being tested yet one of the components of the newer version was only compatible with an older test or other component, then the older version could be instantiated in real time to support the newer version.

The versioning manager 164 can also be employed to various stages of development, production, and/or operations with monitoring/tracking of versions and with instantiation of components during such stages in view of such monitoring/tracking. This can include monitoring of the stages and monitoring of the deployed instances via closed loop feedback while tracking changes in staged versions and initiating automated deployments in view of such monitoring. Versioning via updated applications models and policies can be applied to various stages to ensure, for example, appropriate upgrade of relevant application versions of production instances (e.g., by deploying new version with correct dependencies and/or maintaining past versions when needed to support integration with legacy clients or other applications).

A test manager 170 can be provided that launches a test on the given application 110 based detecting changes in the given application (e.g., detected by the versioning manager 164). Additionally or alternatively, the test can be launched based detecting changes on the dependent relationships between the components and artifacts of the given application. The test manager 170 can restage tests on the given application via the deployment manager 120 from a first testing environment to a second testing environment according to changes detected in the given application 110. The test manager 170 can also implement such restaging based detecting changes on the dependent relationships between the components and artifacts of the given application, wherein the dependent relationships can be determined by the versioning manager 164.

A test model can be generated by the test manager 170 that describes a procedure (e.g., best recommended test given the detected changes) for testing the given application 110 based detecting changes are detected in the given application. Additionally or alternatively, the test model can be generated for testing the given application based detecting changes on the dependent relationships between the components and artifacts of the given application. The test manager 170 can cause the deployment manager 120 to update other components (e.g., operating systems, modules, interfaces, routines, that operate with the application) from the given application 110 in order to repair detected problems in the given application or the other components based on the results of such testing. The application model 110 and/or the policy can be updated to reflect testing requirements for the detected problems, which further can be tracked by the versioning manager.

A portability manager 174 can be provided to cause the deployment manager 120 to deploy versions of other applications that are compatible with the given application based detecting changes in the given application. Additionally or alternatively, the deployment manager 120 can be commanded to deploy such versions of the other applications based detecting changes on the dependent relationships between the components and artifacts of the given application. For example, based on detected changes by the versioning manager 164 in the application 110, different versions of an operating system or other component may be installed to operate with a particular version of the application 110 (e.g., install version 2 of operating system to be compatible with version 5 of application). In a testing scenario, a plurality of differing components may be additionally installed (or removed) to facilitate testing of the application 110 (e.g., install multiple versions of server-side applications to be compatible with current version of client-side application represented by application 110).

The portability manager 174 can also cause the other applications (to be tested with the application 110) to be installed as higher or lower revisions in order to be compatible with the given application 110. The portability manager 174 can also cause the deployment manager 120 to perform rolling upgrades of application instances based on changes that are detected in the given application 110 (e.g., by the versioning manager 164). The portability manager can also command the deployment manager to perform such rolling upgrades based detecting changes on the dependent relationships between the components and artifacts of the given application. In another example, the versioning manager 164 can maintain templates that describe versions of the given application, deployment configurations for the given application, or test recommendations for the given application. Such templates could also be stored as part of the application model 140 and/or the policy 150.

The test manager 170 can configure and launch a test suite of application deployments for the given application 110 via the deployment manager 120. The test manager 170 can configure a plurality of different operational deployment scenarios for the application 110. The configuration and resultant application deployments can be administered across organizational boundaries to suit various organizational needs. For example, development may have one set of needs and production may have a separate set of needs. In some cases, public deployments for the application are configured and launched and in other cases, private deployments are launched such as shown via local testing and storage 180. In other cases, a combination of public and private deployments are launched as configured by the test manager 170 and deployed via the deployment manager 120.

The test manager 170 enables automated development testing, development for operations, and application security development, for example, based on determining best matching infrastructure resources. For instance, such matching can include matching of application models 140 and policies 150 to infrastructure models as specified by the resource offerings and associated metadata 160. The matching infrastructure can then be selected and employed to test or facilitate production while also running various test suites and at different stages of testing. For development testing, the test manager 170 allows developers to follow development of any software with tests in the cloud 130 where they can deploy and run the software in multiple deployment scenarios and execute target test cases without the usual delays and cost to setup deployment and test. After developing and testing of software elements (e.g., applications components), they can then be deployed and operated in production. This enables testing security aspects of the application 110 since security can be tested in a secure development and production environment such as on the local testing and storage 180. Feedback of bugs, security breaches and other detected events can be easily monitored and fed back (e.g., via monitor components and listeners) to development agents such as for diagnostics and repair.

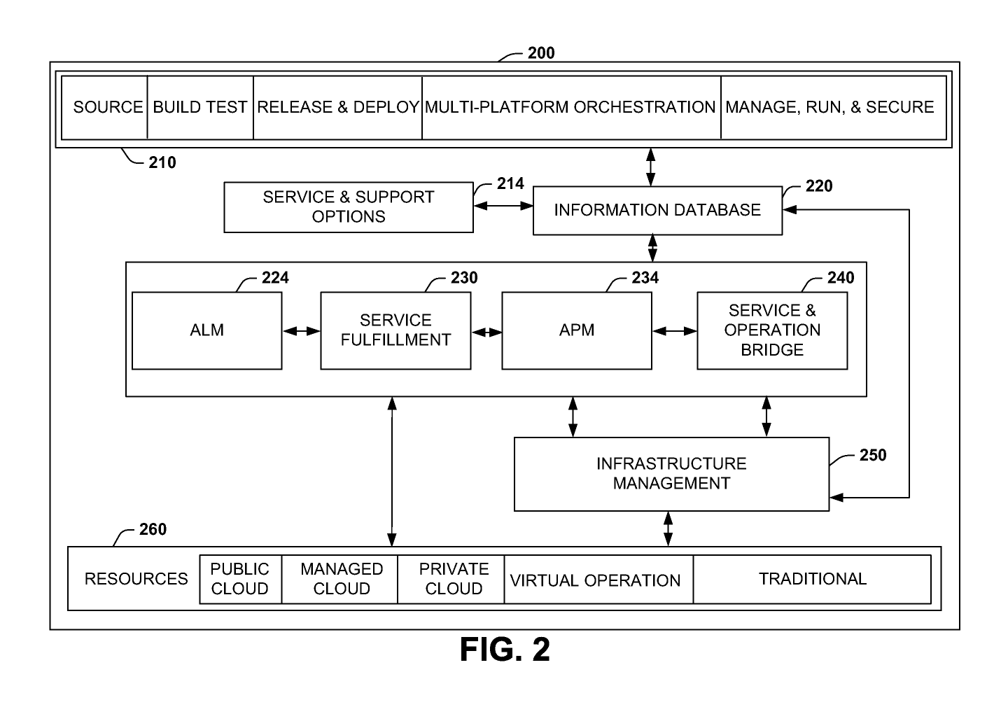

The test manager 170 and deployment manager 120 can be employed to automate testing in accordance with a user interface (UI) (e.g., See FIG. 2) for configuration and launch of test suites on deployments provisioned and deployed by the deployment manager 120. This can include providing automated application programming interfaces (APIs) which can be automated based on monitoring changes in coder repository and launching/running test suites on deployments provisioned and deployed by the deployment manager 120. The deployment manager 120 can be used to move from testing to production which can be initiated by policy changes in terms of location (in production zone) and other production criteria on capacity, delays, quality of service (QoS), and so forth. Other testing scenarios supported by the test manager 170 can include security development, operations development, and quality assurance that can be supported by configured monitoring and closed loop feedback of infrastructure. The results of such development testing for a given application can be utilized by the deployment manager 120 for deployment and lifecycle management for the given application. Continuous integration of application components (e.g., integrated with existing applications they are developed and stored in a repository) can be supported as they are developed based on the deployment manager 120. Continuous delivery of software can also be supported based on the automated actions of the deployment manager 120.

The test manager 170 provides a centralized application management platform for managing and automating within and across application teams and throughout the complete process of developing an application, all within a single workflow. The test manager 170 can support the stakeholders responsible for delivering applications as they progress through their lifecycle. It focuses on the core lifecycle from design through readiness for delivery to operations. This can include requirements management, test planning and functional testing, performance testing, developer management, and defect management. Such application lifecycle activities can be connected together from a workflow perspective with a common management console, layer of project tracking and planning, and built on a common software foundation containing a consistent repository and open integration architecture with a supported software development kit (SDK).

As will be described below with respect to FIG. 2, the test manager 170 can be programmed to support various functions. This can include functions such as Application Lifecycle Management (ALM) with a unified software platform for accelerating the delivery of secure and reliable applications. This includes development management functions that provide a framework for collaboration among developers, testers and business analysts delivering applications. The test manager 170 can also enable defining, managing and tracking software requirements for respective applications. This can include providing a repeatable, scalable, automatable function to manage technical policy and reusable services, for example. Composite applications can be supported via interface components to manage high-quality, reliable, and secure composite applications across the lifecycle. Application lifecycle management includes support for software as a service (SaaS). Quality management functions can also be supported for the application and deployment. This includes performance validation where a set of functions are provided to test application performance in project-based scenarios as well as other development modes. Modular testing tools are also provided for quickly developing automated functional test suites for applications.

Using the test manager 170, specified application requirements guide the development of the applications. Application developers and the specified requirements can be stored in memory to guide the setup of test cases and test suites. The developers and requirements can be defined in terms configurations, deployments and usage scenarios, for example. The different test cases and scenarios can be captured as applications models 140 and policies 150. Representative deployments can be captured as infrastructure templates. Test suites can be run automatically in target configurations at the push of a button (e.g., via web site that points to templates, models, policies, artifacts and executes the code). Periodically or after changes have occurred with the application, such changes can be automated via the test manager 170, such as calling APIs to pass new artifacts and run the tests. Security tests may also test or enable security challenges at various steps of development. Development operations can be enabled by changing the policies to migrate to a production environment with a selected or determined deployment.

The portability manager 174 can be programmed to specify portability instructions which can update the policy 150 and/or application model 140 for deployment of the given application 110 on the cloud 130. In one example, the portability instructions update the policy 150 and/or application model 140 to specify deployments to the deployment manager 120. In another example, the portability instructions may be supplied directly (without updating the policy or application model) to the deployment manager 120 such as though commands that can be provided by an applications programming interface (API), for example. The portability manager 174 can be implemented as including an application programming interface (API) or graphical user interface (GUI), for example, to receive a deployment request. The deployment manager 120 can modify deployment of the given application 110 based on the policy 150 and application model 140 as modified by the portability manager 174. The application model 140 can be employed to characterize a given application 110 for deployment on the cloud infrastructure 130, such as though metadata descriptions for various components of the application.

The deployment manager 120 and portability manager 174 can be implemented via instructions stored in memory and executable by a processor to analyze an application requirement for the given application 110 based on the application model 140 and a policy 150 (or policies) associated with the given application. As will be described below, the policy 150 can be provided to describe additional operating contexts for the application 110 (e.g., operate application after midnight, use only east coast servers, maintain load balancing between servers, and so forth). The deployment manager 120 can then determine a set of infrastructure resources in the cloud infrastructure sufficient to fulfill the application requirement of the application 110 as specified by the model 140 and policy 150. The deployment manager 120 can also change the deployment from deployment A to deployment B based on commands issued by the portability manager 160 to the deployment manager 120.

The system 100 utilizes the capability of dynamic application models 140 (e.g., changeable upon request to alter application deployment) and policies 150 which can also include dynamic infrastructure templates and dynamic binding to provide application and workload portability across potentially heterogeneous hybrid clouds 130 or resource pools. Workload management (e.g., auto scaling, scale up or down of infrastructure resources) can also be provided. For example, based on the loading of cloud infrastructure resources, a scale out/scale in operation may be performed or a move of the application to another location based on policy criteria. The application model 140 or policy 150 can describe how to deploy (or tear down/un-deploy) an application in a portion of a cloud infrastructure utilized for deployment of a given application. For example, the application model 140 or policy 150 can identify infrastructure resources and what is needed from the cloud infrastructure 130 for deployment or retirement of the given application. The portability manager 174 can change the policy 160 and/or application model 140 for a deployment of the application 110 and based on request 170. Such change in deployments can be achieved on another cloud configuration (e.g., from A to B, or vice versa) to provide the desired information to execute the application on the different configuration even if the cloud is based on different APIs, network resources, and so forth. Example reasons for moving the application 110 across different deployments can include load balancing, moving from private to public configurations or vice versa, increasing or decreasing resources for the application, and scaling the application up or down across different infrastructure resources, to name a few.

Moving the application 110 from one deployment to another can include deploying the application via the deployment manager 120 to a different cloud configuration (e.g., or pool of resources), with policy 150 and/or application model 140 specifying the use of infrastructure resources in the different cloud. In such an example, the policy or application model can be adjusted via the portability manager 160 to effect such changes. As mentioned herein, such specifications and commands for moving the application 110 can be initiated via the deployment request 170, which can include a request received via an API or GUI, for example.

As a further example, the application 110 and its corresponding current deployment can be identified by a Real Time Service Model (RTSM), such as can be stored in a repository or database (not shown). The portability manager 174 can call the RTSM to identify the infrastructure resources for the corresponding current deployment and un-deploy/retire the application and infrastructure after the new deployment has been achieved. Such retirement of the old deployment can also be initiated by an API or GUI request, for example.

In addition to moving the application from one deployment to another, the portability manager 174 and deployment manager 120 can cooperate to manage other related aspects of cloud deployment, including workload management, copying and retiring a given application, for example. Workload management can include scaling up or scaling down/workload management of the associated infrastructure resources for deployment of the given application. Workload management can also result from requests to adjust workload for a given deployment (e.g., via GUI or API request). In addition to workload management, deployment (e.g., moving, copying, retiring, of application components) can be utilized for lifecycle management of the given application. For example, a component or system separate from the deployment manager 120 or portability manager 174 can schedule lifecycle operations where current application deployments are changed from their initial deployments due to the lifecycle operations. For example, as part of a scheduled lifecycle operation, a deployment could be initiated via the portability instructions to move, copy, or retire a given application (or its associated components/artifacts) as part of the lifecycle operation. Additionally or alternatively, the lifecycle operation can be triggered based detecting an event (e.g., via feedback).

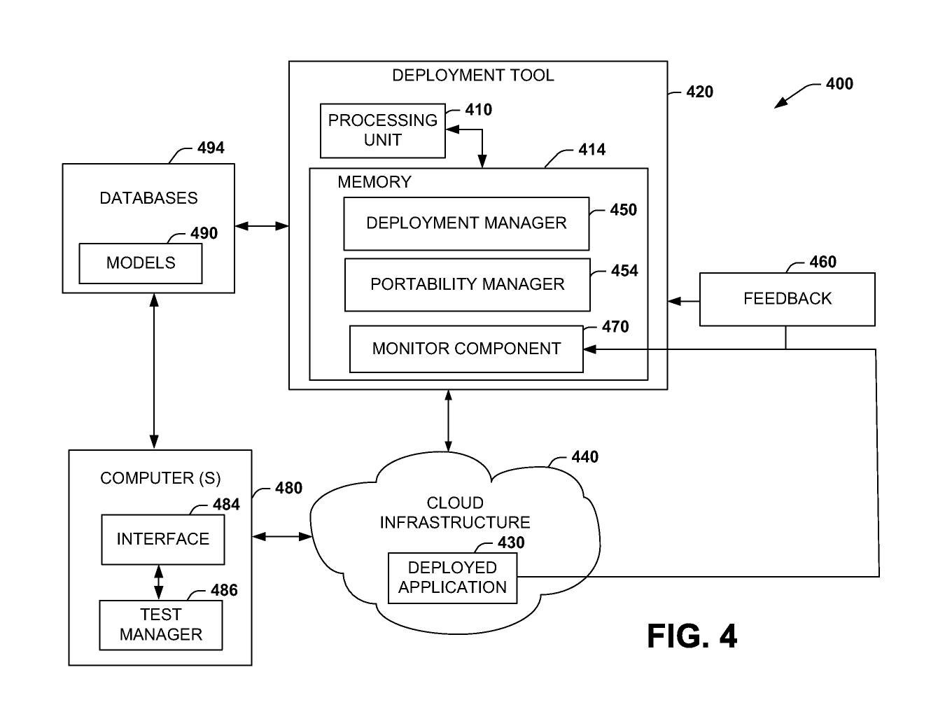

Additional logic can be provided in the deployment manager 120 to process an event received from a monitor (e.g., See FIG. 4). Such monitoring logic can thus detect the occurrence of events and trigger adjustments in resource parameters for a corresponding deployment. As a result and for scaling up, the cloud deployment for the given application 110 can be moved to less loaded environment, for example. New instances of the application 110 can be deployed in a different deployment within the cloud environment. For scaling down, old instances of the application can be un-deployed/retired, such as may identified via the RTSM described above and redeployed based on modified application models 140 and policies 150. Policies 150 and/or application models 140 can also request changing or reconfiguring traffic instances and scaling changes. Workload portability can include moving the complete set of applications to new clouds if needed (e.g., desired/requested by administrator or as a result of monitoring).

Application portability can be provided across infrastructure, clouds or pools that may all be heterogeneous. This can include implementations based on one or multiple hardware (HW) and/or software (SW) configurations. Modules in the system 100 can also be identified on one or multiple HW/SW configurations. Support can also be provided for Software as a Service (SaaS) and virtualized versions of above on HW and/or SW and on the cloud 130.

After an application has been deployed based on the matching, the deployment manager 120 further can manage other aspects of the lifecycle of the application. For example, the deployment manager 120 can monitor feedback, and adjust the infrastructure resources based on such feedback. Additionally or alternatively, the deployment manager 120 can dynamically adjust the application model and corresponding policies based on such feedback or other detected events. Similarly, this can also include retiring older versions of application components (e.g., code, middleware (MW), databases, operating system (OS), and so forth) and installing new versions of components to enable continued deployment of the application in the cloud infrastructure 130.

The cloud 130 can be a hybrid such that it can be a combination of traditional Data Centers that are made to behave like infrastructure resources, private clouds (cloud technology developed on premise), public clouds (offered by service providers and managed cloud configurations (managed on premise or in a public cloud/virtual private cloud). As used herein, the term application applies to a collection of components. In addition, the application can be characterized for each of its components by a set of artifacts (e.g., installer, executable, configurations and so forth, and a set of components that are installed and interact with each other (e.g., code, middleware (MW), databases, operating system (OS), and so forth). Also, as used herein, the term determining can include compiling, enumerating, and matching.

As used herein, the term “substantially” is intended to indicate that while the function or results of the term being modified are a desired or intended result that some variation can result. In this context, for example, the term “substantially match” or variants thereof describes a situation that the resulting analysis and comparison is performed to identify resources that are the same; however, in practice the match can correspond to a set of resources that sufficiently similar to enable deployment (identified above as an absolute or best efforts match).

Where more than one such set of resources might correspond to a match, the deployment manager can select a best matching set of available resources. Other approaches for selecting such match can be utilized.

The application model 140 can be employed to characterize a given application 110 for deployment on the cloud infrastructure 130, such as though metadata descriptions for various components of the application. The deployment manager 120 can be implemented via instructions executable or data readable by a processor to analyze an application requirement for the given application 110 based on the application model 140 and a policy 150 (or policies) associated with the given application. As will be described below, the policy 150 can be provided to describe additional operating context for the application 110 (e.g., operate application after midnight, use only east coast servers, maintain load balancing between servers, deploy within a given network domain, ensure load is between specified limits on servers, ensure there are no upcoming maintenances within a given window, and so forth as well techniques to “measure closeness” of the matches). The deployment manager 120 can then determine infrastructure resources in the cloud infrastructure sufficient to fulfill the application requirement of the application 110 as specified by the model 140 and policy 150.

In one example, the deployment manager 120 can automatically deploy the given application 110 on the cloud infrastructure 130 based on matching of application requirements of the application 110 to the capabilities of the cloud as specified by the resource offerings and metadata 160. As used herein, the term “application” (e.g., including the application 110) can include a set of components that are to be installed and executed. Examples of such components include multiple tiered logic, user interface (UI), middleware (MW), database (DB), operating system (OS) in addition to the code to install and configure or uninstall such components. Thus, the application 110 refers to these sets of components and artifacts which can also include repositories of such components and artifacts. The application 110 can also be identified by pointers to the components and artifacts including individual pointers or pointers to a set of components. In another example, the deployment manager 120 can generate instructions to inform a system (or user) on how to deploy the given application 110 on the cloud infrastructure 130. In either example, the deployment manager 120 can automatically match requirements of the application 110 as specified by the model 140 and policy 150 with capabilities of the cloud 130 as specified by the resource offerings and metadata 160.

The system 100 utilizes a policy and model-driven approach to automate deployment as opposed to manual procedures of conventional systems. The system 100 can dynamically (or statically) optimize and bind infrastructure resources (characterized by metadata properties) to applications 110 based on models 140 and policies 150 that characterize their requirements in terms of infrastructure properties. This can include matching application metadata to resource metadata as well as taking into account policies and context to automate optimized or preferred/labeled deployment of applications and their components/dependencies on the cloud 130 without also requiring manual deployment steps. In one example, the system 100 allows tracking of instances while also supporting automated management of such instances (e.g., automated monitoring and feedback described below). Different techniques are provided to ingest, author, and design metadata that can also describe infrastructure templates, application models, and policies. Such instances can be stored in a database or repository (not shown) along with the application 110, application model 140, and policy 150.

The system 100 can employ closed feedback loops (See FIG. 4) for monitoring applications. Such monitoring applications can be utilized to scale up or scale down an application execution requirement, for example, as well as to notify appropriate recipients, such as users or other system applications. In one example, listeners can be installed in various components to capture events from monitoring. Events received by listeners can trigger handlers that can generate lifecycle management operations on the system 100. Examples of some lifecycle management operations include scale up, scale down, move, de-provision, alert user or system, or run another executable, which may involve composition of the systems described herein and other applications.

The system 100 can be implemented on one or across multiple hardware platforms, wherein the modules in the system can be executed on one or across multiple platforms. Such modules can run on cloud technology (various forms/and hybrid clouds) or offered as a SaaS (Software as a service) that can be implemented on or off the cloud. Complex applications can be automatically deployed on required infrastructure resources without also requiring users to understand how to perform such operations. Policies 150 provide automated instructions for operating guidelines that help administrators mitigate deployment errors. Metadata can also be associated with the application by identifying the type of application (e.g., via UI or API), then the user does not need to understand the application characteristics. This approach allows “best practice”, recommended or otherwise imposed deployment models for applications based on their association to metadata.

Policies also allow separating the application characteristics from other contextual considerations (e.g., about user, about application, about infrastructure, about context, about that specific user, about that specific application, and so forth. This facilitates the reuse of the application models across numerous applications. Particularization (e.g., specify a particular set of policies for one application or a given version thereof versus another) can also be achieved via policies. This can be one approach utilized by the system to impose that a specific set of characteristic values are fixed for a given application or version. For example, the system could apply a generic application model for web applications, yet in another case, explicitly specify a different model or certain values for the attributes of the model. Resources can also be provided from hybrid clouds (e.g., some resources provided from local databases and servers and some resources provided from Internet services).

For purposes of simplification of explanation, in the example of FIG. 1, different components of the system 100 are illustrated and described as performing different functions. However, one of ordinary skill in the art will understand and appreciate that the functions of the described components can be performed by different components, and the functionality of several components can be combined and executed on a single component. The components can be implemented, for example, as computer executable instructions, hardware (e.g., an application specific integrated circuit or a processing unit), or as a combination of both. In other examples, the components could be distributed among remote devices across a network. In one example, topologies can be defined where an applications template can include a topology model of which components should be deployed (e.g., what component to be deployed at which location). In another example, the deployment manager 120 could be provided with a topology model and then determine the best infrastructure resources to match it. In yet another example, after provisioning of the resources and deployment of the application components, a topology instance can be created. The topology instance can be stored and used for later management, monitoring, as disclosed herein.

FIG. 2 illustrates an example of a test manager interface 200 (also referred to as interface 200) for automated test, versioning, and deployment of applications in a cloud environment. The interface 200 includes a selection pane 210 that enables source code modifications and design, building and lunching of test suites, release and deployment options, multi-platform orchestration (e.g., synchronizing events between application components), and managing, running, and securing application environments. Such selection panes as described herein can also be exposed to other applications via an applications programming interface (API), for example. Service and support options 214 include service governance (e.g., financial agreements, capacity, vendor information, and so forth). Service marketplace options in the service and support options 214 include service stores, product stores, or catalog requests to fulfillment, usage data, and chargeback information. A support hub in the options 214 can include case exchanges and application management details. The options 214 can also include collaborative case management such as reporting and tracking of incidents, problems, defects, requirements, changes, and release data for the application. An information database 220 can store/exchange data to/from each of the components described herein with respect to the interface 200.

An application lifecycle manager 224 can include options for designing, modeling, building, and testing application including composite or hybrid applications. A service fulfillment component 230 enables service design composition and fulfillment, application modeling, deployment, and workload management, along with infrastructure design and fulfillment. An application performance module (APM) enables performance testing, analytics, and sizing of the deployed applications. A service operation and bridge component 240 enables event processing, monitoring, analytics, and reporting along with interaction with a real time service model (RTSM) repository. An infrastructure management component 250 provides options for defining/searching system components, network components, and storage components. This includes options for processing/analyzing faults, analyzing application, network, and/or system performance, and providing various configuration interfaces for configuring the options. A resources pane 260 includes options for specifying how applications are to be deployed including options for deployment on public clouds, managed clouds, private clouds, virtual operation, and traditional deployments (e.g., according to a standard deployment scenario).

The interface 200 and associated test manager described herein (e.g., test manager 170 of FIG. 1) enable development testers and security developers to have full automation for the deployment of applications for test and associated test suites. This includes model-based automation, which further facilitates and accelerates the development process. The interface 200 facilitates the creation of models and configurations to be employed therewith. This can include hybrid delivery model where testing can be on private cloud, public cloud, or testing can be partially on private and public cloud (e.g., burst when test capacity requires (e.g., for load testing)). Testing can be automatically moved from private clouds to public cloud and conversely.

Operations developers are also provided full automation for the deployment of applications from development and testing to production. This includes full automation of the life cycle management under operation. Model-based automation enables building and reusing models created from similar applications and/or used at development and testing. This also includes testing of hybrid delivery models including public and/or private cloud deployments and testing as previously described. This can include monitoring the source repository to detect changes and to launch tests automatically. This can also include options for periodic, manual and scheduled testing, as well.

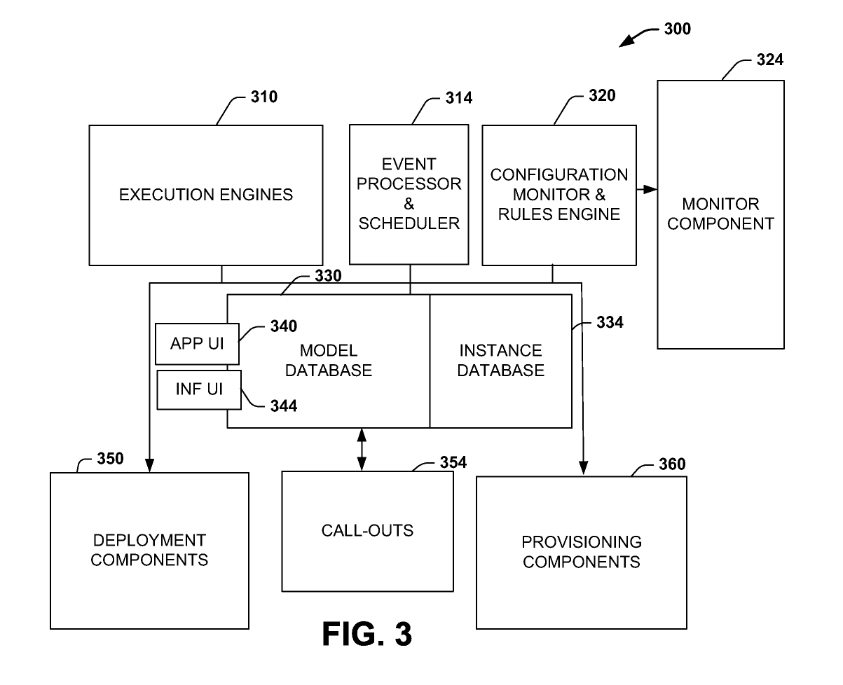

FIG. 3 illustrates an example system 300 for automated deployment, versioning, and monitoring of applications. The system 300 includes execution engines 310 for automated deployment of applications. Such engines can also include provisioning managers for establishing service level agreements with service providers and can include the deployment manager described above. An event processor and scheduler can 314 can be utilized for processing application events and scheduling tasks associated with the application. As disclosed herein, listeners/handlers can be defined and installed for monitoring events. This can include scheduling the provisioning/deployment and follow-up lifecycle management operations (e.g. tonight or deploy for next 2 weeks). A configuration monitor 320 and rules engine can be employed for configuring a monitor component 324 which provides feedback from an application and for applying rules and policies for executing the application.

The system 300 includes a model database 330 that can include application models, infrastructure models, and artifact pointers, for example. An instance database 334 can be employed to store realized target instances of the application. An application user interface 340 can be employed to design the application and configure metadata for operating the application, whereas an infrastructure user interface 244 can be employed to specify infrastructure requirements for deploying the application in the cloud. Deployment components 350 can include a deployment application programming interface (API) and instructions such as may be specified via a deployment recipe, for example. One or more call-outs 354 can specify customized operating instructions for a given application. Provisioning components 360 can include a provisioning API and plug-ins for interacting with various cloud infrastructure components.

The system 300 can be utilized as a designer tool to build/deploy infrastructure and application templates. It also allows application developers, testers, or other administrators or designers to build application models. Similarly, they can design policies and rules for execution and deployment of an application. Some or all of the infrastructure and application data can be ingested into the repositories shown as database 330 and 340, respectively. Alternatively, such infrastructure or application data can be passed via APIs. Application artifacts (code, executable, installation packages, and the like) can be also ingested or referred to via the databases or API's. The APIs or portal user interfaces 340 and 344 can be used to associate or upload requests to match and deploy while also specifying application templates and policies to use, for example. Such APIs and user interfaces can be implemented as part of a designer tool to define metadata and associate the metadata to infrastructure (e.g., via infrastructure templates and topologies).

Preparation and setup of agent and monitoring tools/can be provided such that applications can discover the instances (which have been instrumented and with agents if needed). This can be achieved via instruction/recipes utilized to deploy infrastructure and application elements after binding the application and its associated components to the infrastructure resources. Events/reports allow closed feedback loops that can be used to scale up/scale out (based on policy) or update context/policies for future changes if allowed by policies as well as notify appropriate parties or systems (See FIG. 4 and description below). As noted above, clouds and resource pools can be hybrid entities where some resources are served locally and some remotely. For clouds or hardware resources that can support auto-scaling, workload management and handling of assurance/monitoring events, the application can be self managed. Such self management, for example, utilizes feedback to determine performance, alter application requirements, and generate alerts as appropriate.

FIG. 4 illustrates an example system 400 utilizing closed loop feedback to facilitate portability, testing, versioning, deployment, and monitoring of applications. The system 400 includes a processing unit 410 (e.g., a processor) that executes instructions from a memory 414. The memory 414 includes any storage media (e.g., volatile or non-volatile) configured for storing computer executable instructions associated with a computer. The processing unit 410 and memory 420 can be provided as part of a deployment tool 420 that deploys an application 430 on a cloud infrastructure 440 via a deployment manager 450 as commanded by a portability manager 454. As shown, feedback 460 is received from the deployed application 430 and processed by a monitor component 470. Such feedback 460 can be status or events from the deployed application 430 which indicate how the application is executing. In one example, the feedback 460 can be employed to adjust operating parameters of the deployed application 430, which have been set according to previously determined application requirements. For instance, a foreground task may be adjusted such that the task operates over a differing number of milliseconds than presently being executed. This can include scaling up or down operating requirements of the deployed application 430. In another example, the feedback 460 may be employed to adjust operating infrastructure of the cloud 440. For example, service level agreements may be automatically renegotiated with cloud infrastructure service providers to increase or decrease available resources to properly meet operating needs of the deployed application 430.

A computer 480 can operate one or more interfaces 484 and a test manager 486 to program application models 490 and stored in databases 494. The test manager 486 can also operate with the deployment manager 450 and portability manager 454 as previously described with respect to FIG. 1. The computer can also interact with the deployment tool 420 to alter deployment and facilitate lifecycle management of applications. The interfaces 484 can also configure infrastructure templates, alter operating requirements, configure the monitor component 470, and interact with events and alerts that are generated within the system 400. As noted previously, along with being executed on the cloud, the deployed application 430 can be spread across unrelated clouds or provided as part of a hybrid application. For example, the deployed application 430 could be executed in part on the cloud infrastructure 440 and in part on the databases 494 which are a different entity (e.g., local server databases versus network databases) than the cloud.

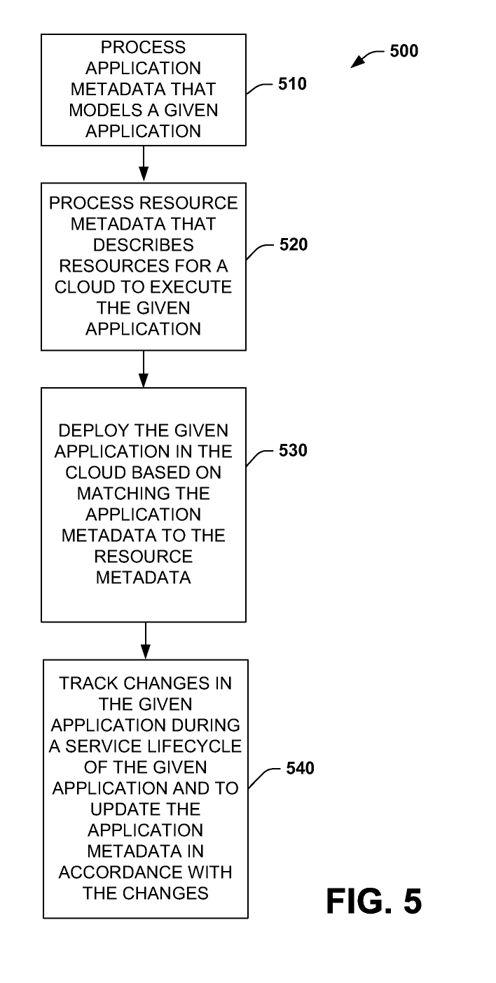

FIG. 5 illustrates an example method 500 for automated deployment and versioning of applications. At 510, the method 500 includes processing application metadata that models a given application (e.g., via deployment manager 120 of FIG. 1). The method 500 includes processing resource metadata that describes resources for a cloud to execute the given application at 520. At 530, the method 500 includes deploying the given application in the cloud based on matching the application metadata to the resource metadata in order to execute the suite of tests. At 540, the method 500 includes tracking changes in the given application during a service lifecycle of the given application and to update the application metadata in accordance with the changes. The method 500 can also include automatically launching a test based detecting the changes in the given application and automatically installing other components compatible with the changes. The method 500 can also include automatically deploying the given application on at least one of a public or private cloud. The method 500 can also include monitoring changes for the given application in a repository and automatically launching a suite of tests based on detection of the changes.

The method 500 can be automatically executed as part of a system such as the example depicted in FIG. 1 or 4. The system can include a memory for storing computer executable instructions associated with a computer and a processing unit for accessing the memory, executing the computer executable instructions, and thereby performing the method 500. The computer executable instructions can include an application model stored in the memory to characterize a given application for deployment on a cloud infrastructure, wherein the application model can be described by application metadata. A deployment manager stored in the memory can analyze the application metadata for the given application and a policy associated with the given application to determine infrastructure resources in the cloud infrastructure. The infrastructure resources can be specified as resource metadata. The deployment manager can automatically substantially match (e.g., identify a closest match) the application metadata with the resource metadata to fulfill an application requirement. A versioning manager can track changes in the given application during a service lifecycle of the given application and update the application model or the policies in accordance with the changes. The system can also include a test manager stored in the memory to configure and launch a test suite of application deployments in the cloud for the given application via the deployment manager based detecting changes in the given application.

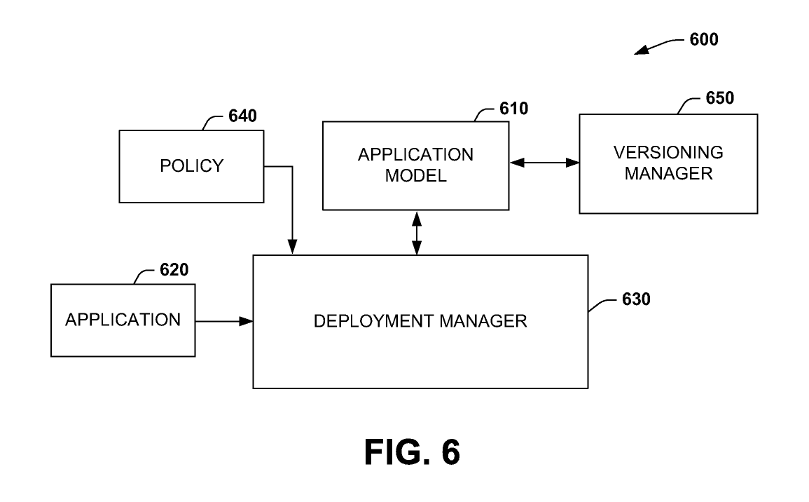

FIG. 6 illustrates an example deployment system 600 for automated deployment and versioning of cloud applications. The system 600 includes an application model 610 to characterize a given application 620 for deployment on a cloud infrastructure such as shown above with respect to FIG. 1. A deployment manager 630 analyzes an application requirement for the given application 620 based on the application model 610 and a policy 640 associated with the given application to determine infrastructure resources in the cloud infrastructure to fulfill the application requirement. A versioning manager 650 can track changes in the given application 620 during a service lifecycle of the given application and to update the application model 610 or the policies 640 in accordance with the changes.

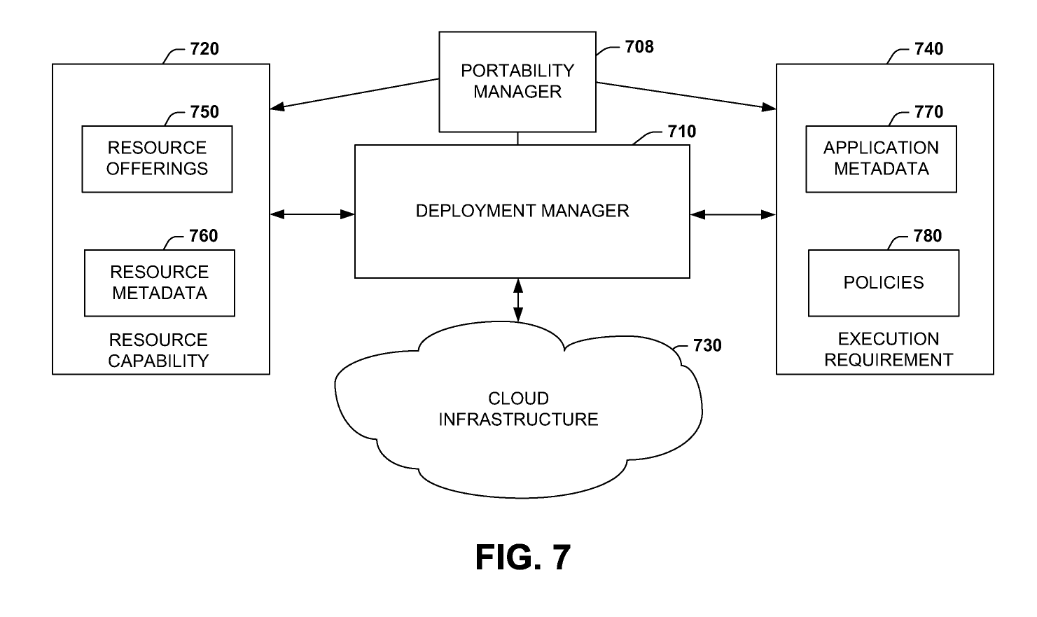

FIG. 7 illustrates an example of a portability manager 708 and deployment manager 710 for correlating a resource capability 720 for a cloud infrastructure 730 with an application requirement 740 of an application. The versioning manager and test manager described above can be employed with the portability manager 708 and deployment manager 710 and cooperate for testing, deployment, versioning, and management, as previously described. The portability manger 708 cooperates with the deployment manager 710 to change deployments on the cloud infrastructure 730 as described above with respect to FIG. 1. The resource capabilities 720 can include resource offerings 750 that can be from a pool of resource offerings provided by a plurality of resource providers that support the cloud 730. Such resource offerings can include one or more of cloud services (e.g., accessible via corresponding application program interfaces (APIs)), existing systems that can activate and provision such services, or existing external compositions (parameterized workflow/composition script with functions calls), for example. The resource offerings 750 can be compiled by/ingested from resource providers.

The resource capability 720 also includes resource metadata 760 associated to each resource offering that characterize properties of interest of the resource. The resource metadata can be generated, for instance, based on the resource offerings, such as at ingest thereof. For example, such metadata 760 can specify location/topologies (e.g., for composite resources), hardware, CPU, memory, operating system included or supported, other software aspects, and labels among other specifications, capacities, SLAs, scheduled maintenances, workload (if already in partial use). The resource metadata 760 can be associated to any resource designed or added to the resource pool by the resource design or ingestion process. Metadata describing the applications models and resource offerings can be captured via designer (e.g., a tool, Portal UI or APIs) to describe the metadata. Metadata including recipes (e.g., corresponding to instructions for deployment and other lifecycle management functions such as un-deployment and monitoring) can constitute resource templates. The resource metadata 760 and the associated resource offerings 750 that are specified by the metadata can be provided as part of a template (e.g., data file of metadata and offerings) that can be utilized by other applications.

The execution requirement 740 of the given application can be specified via application metadata 770 that can be defined at or after application design. This can include components to be individually deployed (e.g., multiple applications in multiple tiers). The application metadata 760 can also specify requirements/preferences on resources. This can include generic deployment scripts as workflow or processes (asynchronous or synchronous). The deployment scripts can further include deployment instructions for each component (e.g., script to run on allocated resource, instruction to services, and so forth). This can include associated instructions to deploy agents or prepare for monitoring and/or management. Instructions can be applied across components. For example, the application metadata 770 can represent the application models described above with respect to FIG. 1. A given application model can be stored in memory and utilized by multiple applications to facilitate deployment thereof. As noted previously, an application can include a plurality of cooperating components and artifacts (e.g., sources or executable and installable) provided with the applications that are utilized by the deployment scripts.

As shown, additional policies 780 can be provided that apply to the application/Infrastructure and refer to context for operating an application. For example, a policy may specify a location for an application (e.g., only operate on east coast servers), a time (e.g., operate after midnight and before 6:00 AM), a processing requirement (e.g., processing speed and memory needs specified), and/or a load balancing requirement (e.g., no server is to operate with over 50% load), SLAs, availability requirements (e.g. no scheduled maintenance within next x days), security (e.g., a particular network domain or security domain). As disclosed herein, the policy can be programmable and be modified, such as based a request (e.g., a deployment request or request triggered based detecting one or more events).

Applications can be deployed by the deployment manager 710 as commanded by the portability manager 708 by retrieving the associated metadata 770 and matching resource offerings 750 available in the pool of resources based on best match (can be exact labeling if for example imposed by policies). Matching of resource metadata 760 to application metadata 770 can be according to strict specifications (e.g., processors must operate at 1 GHZ) or can be matched according to threshold specification (e.g., any processor operating over 500 MHZ is acceptable). Thus, matching can be absolute matching or can be substantial matching where the matching is best fit or close to the desired match criteria. Recipes can be processed by the deployment manager 710 and refer to the code/artifact to use for application deployments. Such recipes can be made available via a known repository location or referred to via a pointer to the recipe, for example. Topologies of composite resources that correspond to an application can be saved as a new resource type by the deployment manager 710 for reuse such as in circumstances where similar application metadata is used by another application, for example. Multiple versions of the same applications or similar applications can reuse the same application metadata and application model but, for example, each of which may employ different policies to establish an operating context for each respective application.

What have been described above are examples. It is, of course, not possible to describe every conceivable combination of components or methods, but one of ordinary skill in the art will recognize that many further combinations and permutations are possible. Accordingly, the invention is intended to embrace all such alterations, modifications, and variations that fall within the scope of this application, including the appended claims. Additionally, where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

What is claimed is:

1. A system comprising:
an application model, stored in memory, to characterize a given application for deployment on a cloud;
a deployment manager, corresponding to instructions executable by a processor, to analyze an application requirement for the given application based on the application model and policies associated with the given application to substantially match infrastructure resources in the cloud to fulfill the application requirement; and
a versioning manager, corresponding to instructions executable by the processor, to track changes in the given application during a service lifecycle of the given application and to update at least one of the application model or the policies in accordance with the changes in the given application.

2. The system of claim 1, wherein the versioning manager is further to model dependent relationships between components and artifacts of the given application which are updated in the application model or the policies based on changes being detected in the given application.

3. The system of claim 2, further comprising a test manager to launch a test on the given application based on detecting changes in the given application or based on detecting changes on the dependent relationships between the components and artifacts of the given application.

4. The system of claim 3, wherein the test manager is to command the deployment manager to update other components from the given application to repair detected problems in the given application or the other components after testing.

5. The system of claim 4, wherein the application model or the policies are updated to reflect testing requirements for the detected problems.

6. The system of claim 1, wherein the at least one of the application model or the policies is updated in response to an input, the input provided by a manual procedure, tool, or logical process.

7. The system of claim 1, wherein the versioning manager enables an older version of a component to be instantiated in real time to support an newer application revision.

8. The system of claim 1, further comprising a portability manager that causes the deployment manager to deploy versions of other applications that are compatible with the given application based detecting changes in the given application or based detecting changes in dependent relationships between components and artifacts of the given application.

9. The system of claim 8, wherein the portability manager causes the other applications to be installed as higher or lower revisions in order to be compatible with the given application.

10. The system of claim 8, wherein the portability manager cause the deployment manager to perform rolling upgrades of application instances based detecting changes in the given application or based detecting changes on the dependent relationships between the components and artifacts of the given application.

11. The system of claim 1, wherein the versioning manager maintains templates that describe versions of the given application, deployment configurations for the given application, or test recommendations for the given application that are utilized by the deployment manager for deployment.

12. A method comprising:
processing, by a computer, application metadata to model a given application;
processing, by the computer, resource metadata to describe resources for a cloud to execute the given application;
deploying, by the computer, the given application in the cloud based on matching the application metadata to the resource metadata; and
tracking changes in the given application during a service lifecycle of the given application and updating the application metadata in accordance with the changes.

13. The method of claim 12, further comprising automatically launching a test application based detecting the changes in the given application and automatically installing other components compatible with the changes.

14. A system, comprising:
a memory for storing computer executable instructions associated with a computer; and
a processing unit for accessing the memory and executing the computer executable instructions, the computer executable instructions comprising:
an application model stored in the memory to characterize a given application for deployment on a cloud, wherein the application model is described by application metadata;
a deployment manager stored in the memory to analyze the application metadata for the given application and policies associated with the given application to determine infrastructure resources in the cloud, wherein the infrastructure resources are specified as resource metadata and the deployment manager automatically matches the application metadata with the resource metadata to fulfill an application requirement; and
a versioning manager, corresponding to instructions executable by the processing unit, to track changes in the given application during a service lifecycle of the given application and to update the application model or the policies in accordance with the changes.

15. The system of claim 14, further comprising a test manager stored in the memory to configure and launch a test suite of application deployments in the cloud for the given application via the deployment manager based detecting changes in the given application.
